(19) United States
(12) Patent Application Publication
(10) Pub. No.: US 2012/0025739 A1
(43) Pub. Date: Feb. 2, 2012

(54) LED ILLUMINATING DEVICE, AND DISPLAY DEVICE PROVIDED WITH THE LED ILLUMINATING DEVICE

(75) Inventor: Akira Tomiyoshi, Osaka (JP)

(73) Assignee: SHARP KABUSHIKI KAISHA, Osaka (JP)

(21) Appl. No.: 13/260,885

(22) PCT Filed: Nov. 6, 2009
(86) PCT No.: PCT/JP2009/068951

§ 371 Date: Sep. 28, 2011

(30) Foreign Application Priority Data
Mar. 31, 2009 (JP) 2009-084007

(51) Int. Cl. H05B 37/02

(52) U.S. Cl. 315/312

(57) ABSTRACT

In order to obtain an LED illuminating device which reduces the wire connection cost by reducing the number of wiring lines and which can also reduce the substrate cost even with a configuration in which the light-emitting surface is formed by combining a plurality of LED unit substrates and in order to obtain a display device which reduces the manufacturing cost by using this LED illuminating device, an LED illuminating device 1 is configured such that a first LED unit substrate 3A having an LED drive circuit section 5 mounted on the substrate and a second LED unit substrate 3B having no LED drive circuit section 5 mounted on the substrate are used in combination and such that the second LED unit substrate 3B is driven via the LED drive circuit section 5 mounted on the first LED unit substrate 3A, and a display device 10 is configured with this LED illuminating device 1 as the backlight.

### TECHNICAL FIELD

The present invention relates to an LED illuminating device and a display device, and more particularly to an LED illuminating device which is capable of illumination as a planar light source by arranging a plurality of LEDs in a planar fashion, and a display device provided with this LED illuminating device.

### BACKGROUND ART

As light-emitting efficiency improves and the amount of light emission increases, illuminating devices using light-emitting diodes (LEDs) which are considered to have a long life span and small power consumption and to be easy for the environment have recently been put into practical use. Furthermore, ever since the development of blue LEDs, light source devices have also been developed which emit white light by using these blue LEDs and white LEDs that make use of a fluorescent substance or by using LEDs that emit three primary colors, blue, red, and green.

Light source devices using LEDs facilitate control of the luminance of emitted light and control of the light emission time, and are therefore suitable as light source devices that require brightness adjustment.

Therefore, it has already been proposed to use an LED mounting substrate on which numerous LEDs are mounted in a planar fashion as a planar LED illuminating device for the light source of the backlight of a liquid crystal display device (for example, see Patent Document 1).

When an LED illuminating device is used as the backlight of a liquid crystal display device, power consumption is reduced, so the effect of extending the life span of the light source is exhibited. Moreover, compared to a conventional backlight light source using a cold cathode fluorescent lamp, having a configuration in which LEDs are arranged in a planar fashion also makes a reduction in the thickness of the light source portion possible, so this becomes effective for lowering the profile of a liquid crystal display device.

### RELATED ART DOCUMENTS

### Patent Documents

Patent Document 1: Japanese Patent Application Laid-Open Publication No. 2006-128125

### SUMMARY OF THE INVENTION

### Problems to be Solved by the Invention

When LEDs are caused to emit light, an appropriate amount of power is supplied to wiring that is connected to each of the LEDs to cause each LED to emit light with the desired brightness. For this reason, the LED illuminating device is provided with an LED drive circuit section for supplying respectively appropriate amounts of power to the individual LEDs and an LED drive circuit control section for supplying control signals that control this LED drive circuit section. In addition, with a fractional-type light-emitting surface in which a single light-emitting surface is produced by dividing the light-emitting surface and combining a plurality of substrates each having LEDs mounted thereon, it becomes necessary to individually wire the LEDs mounted on each of the LED unit substrates to the respective LED drive circuit sections, so the number of wiring lines is increased, and wiring becomes complex, thus creating the problem of increased wire connection cost.

If a configuration is devised in which the LED unit substrates have respective LED drive circuit sections mounted thereon as an integral unit, the number of lines connecting the unit substrates to each other is reduced, so the wire connection cost can be suppressed. However, this configuration requires wiring layers for electrically connecting the individual LEDs to electronic components provided in the LED drive circuit sections and therefore tends to increase the number of substrate layers, so the substrate cost is increased. Moreover, if a backlight is configured by mounting LEDs on the entire substrate surface, because LED drive circuit sections are mounted in regions where no LED is mounted, this results in a configuration in which the components are mounted over the entire substrate surface, thus creating the problem of increased substrate cost.

Therefore, there is a desire for an LED illuminating device that reduces the cost of wire connection between the respective LEDs and LED control circuits and that can also reduce the substrate cost even if this is a multifractional-type LED illuminating device provided with a plurality of LED unit substrates. In addition, there is a desire for a display device that reduces the manufacturing cost by using an LED illuminating device that has a reduced substrate cost as the backlight.

In light of the problems described above, the present invention has as its object to provide an LED illuminating device that reduces the wire connection cost by reducing the number of wiring lines and that can also reduce the substrate cost even with a configuration in which a plurality of LED unit substrates are combined to form a light-emitting surface, and also has as its object to provide a display device that reduces the manufacturing cost by using this LED illuminating device.

### Means for Solving the Problems

In order to achieve the aforementioned objects, the present invention is an LED illuminating device including an LED unit substrate on which a plurality of LEDs are mounted, an LED drive circuit section, and a drive circuit control section, wherein a first LED unit substrate having the aforementioned LED drive circuit section mounted on the substrate and a second LED unit substrate having no LED drive circuit section mounted on the substrate are provided as the aforementioned LED unit substrate, and the aforementioned second LED unit substrate is driven via the aforementioned LED drive circuit section mounted on the aforementioned first LED unit substrate.

Because this configuration uses a first LED unit substrate having a high substrate cost by mounting LEDs and an LED drive circuit section and uses a second LED unit substrate having a low substrate cost without any mounted LED drive circuit section, the substrate cost can be reduced, as compared to a configuration that uses the first LED unit substrate(s) for the entire LED unit substrate. Furthermore, compared to a case in which the number of wiring lines is increased by having the second LED unit substrate(s) for the entire LED unit substrate in order to electrically wire an externally provided LED drive circuit section and each of the LEDs, the wire connection cost can be reduced because the first LED unit substrate and the second LED unit substrate can be connected with a smaller number of wiring lines.

Moreover, the present invention is the LED illuminating device configured as described above, wherein in the formation of a light-emitting surface by disposing the aforementioned LED unit substrate on one surface of a backlight chassis, the aforementioned second LED unit substrate is disposed in a region that becomes a high-temperature portion when light is emitted. With this configuration, the second LED unit substrate without any mounted LED drive circuit section is disposed in a region that readily rises to a high temperature, which means that the LED drive circuit section is provided in a position which avoids the high-temperature portion. Therefore, even when the LED drive circuit section generates heat, it is possible to suppress any further temperature increase in a region that is prone to become a high-temperature portion due to the emission of light of the numerous LEDs.

In addition, the present invention is the LED illuminating device configured as described above, wherein the aforementioned LED illuminating device is a planar illuminating device in which the aforementioned LED unit substrates are arranged in a planar fashion on the backlight chassis, with the aforementioned first LED unit substrate being disposed in the peripheral portion of this plane, and the aforementioned second LED unit substrate being disposed on the inside of this, and the aforementioned first LED unit substrate and the aforementioned second LED unit substrate are electrically connected via an LED inter-substrate connecting section. With this configuration, the second LED unit substrate without any mounted LED drive circuit section is disposed in the central portion of the light-emitting surface that becomes a high-temperature portion during light emission, so a rise in the temperature of the LEDs can be suppressed by suppressing the temperature increase in the central portion of the light-emitting surface.

Furthermore, the present invention is the LED illuminating device configured as described above, wherein the aforementioned second LED unit substrate is formed of a plurality of small-width substrates, with the width of each being sufficiently small that the LEDs can be mounted in a row or column. This configuration can reduce the substrate area of the second LED unit substrate, so the substrate cost can be reduced even further.

Moreover, the present invention is the LED illuminating device configured as described above, wherein the aforementioned first LED unit substrate is disposed on one of the side portions of the aforementioned light-emitting surface, while the aforementioned second LED unit substrate is disposed on the other side portion. With this configuration, a planar LED illuminating device with a specified surface area can be obtained by connecting the second LED unit substrate having a specified length to the side portion of the first LED unit substrate.

In addition, the present invention is the LED illuminating device configured as described above, wherein another set of the aforementioned second LED unit substrate is additionally linked to the aforementioned second LED unit substrate via another set of the aforementioned LED inter-substrate connecting section. With this configuration, a planar LED illuminating device having an even larger size can be obtained by providing a plurality of second LED unit substrates together on the side portion of the first LED unit substrate.

Furthermore, the present invention is the LED illuminating device configured as described above, wherein the aforementioned first LED unit substrates are disposed on both of the side portions of the aforementioned light-emitting surface, and the aforementioned second LED unit substrate is disposed therebetween. With this configuration, because three types of unit substrate, i.e., the first LED unit substrate, the second LED unit substrate, and the first LED unit substrate, are provided together, an LED illuminating device with a large surface area can be obtained. Moreover, because the LED drive circuit sections that become the source of heat generation are provided in the side portions that become relatively low-temperature portions, the temperature increase in the central portion that reaches a relatively high temperature is suppressed, thus making it possible to achieve uniformity in the temperature over the entire surface of the light-emitting portion.

In addition, the present invention is the LED illuminating device configured as described above, wherein a plurality of substrates are provided together as the aforementioned second LED unit substrate, and each of the substrates is connected to one of the aforementioned first LED unit substrates on the two side portions. With this configuration, an even larger planar LED illuminating device can be obtained.

Furthermore, the present invention is the LED illuminating device configured as described above, wherein the aforementioned light-emitting surface is planar in the up-down direction, and the aforementioned first LED unit substrate is provided on the lower side of this light-emitting surface, while the aforementioned second LED unit substrate is provided on the upper side. In a light-emitting surface that is planar in the up-down direction, the upper portion thereof tends to become a high-temperature portion, so by providing the LED drive circuit section toward the bottom, this configuration prevents the upper portion from increasing the temperature even further and can therefore suppress the temperature increase of the LEDs.

Moreover, the present invention is a display device including a liquid crystal display panel and the LED illuminating device of any one of claims 1 to 9 as the backlight of the aforementioned liquid crystal panel.

This configuration makes it possible to obtain a display device having a large screen size, and because an LED illuminating device that reduces the wire connection cost and substrate cost is used, the cost of manufacture of the display device can be reduced.

In addition, the present invention is the display device configured as described above, wherein the drive circuit control section that supplies a control signal to the LED drive circuit section provided in the aforementioned LED illuminating device is disposed on the surface of the backlight chassis on the side opposite from the LED mounting surface. With this configuration, there is no need to expand the frame of the display portion more than the LED mounting portion, so the frame portion of the display device can be made narrower.

### Effects of the Invention

With the present invention, an LED illuminating device is devised, which includes a first LED unit substrate having a plurality of LEDs and an LED drive circuit section mounted on the substrate, as well as a second LED unit substrate having only a plurality of LEDs mounted on the substrate without any mounted LED drive circuit section, and the aforementioned second LED unit substrate is driven via the LED drive circuit section mounted on the aforementioned first LED unit substrate. It is therefore possible to obtain an LED illuminating device that reduces the wire connection cost and that can also reduce the substrate cost. Furthermore, because a display device provided with this LED illuminating device as the backlight is devised, a display device that can reduce the manufacturing cost can be obtained.

### BRIEF DESCRIPTION OF THE DRAWINGS

FIG. 1 is a schematic explanatory diagram of an LED illuminating device according to the present invention; FIG. 1(a) shows an overall plan view including first LED unit substrates and second LED unit substrates, FIG. 1(b) is a model diagram showing one example of a first LED unit substrate, and FIG. 1(c) is a model diagram showing one example of a second LED unit substrate.

FIG. 2 is a schematic explanatory diagram of a first embodiment of the LED illuminating device according to the present invention.

FIG. 3 is a schematic explanatory diagram of a second embodiment of the LED illuminating device according to the present invention.

FIG. 4 is a schematic explanatory diagram of a third embodiment of the LED illuminating device according to the present invention.

FIG. 5 is a schematic explanatory diagram showing the sectional structure of a display device according to the present invention.

### DETAILED DESCRIPTION OF EMBODIMENTS

Embodiments of the present invention will be described below with reference to the figures. Furthermore, note that the same reference characters are used for the same structural members, and a detailed description will be omitted as appropriate.

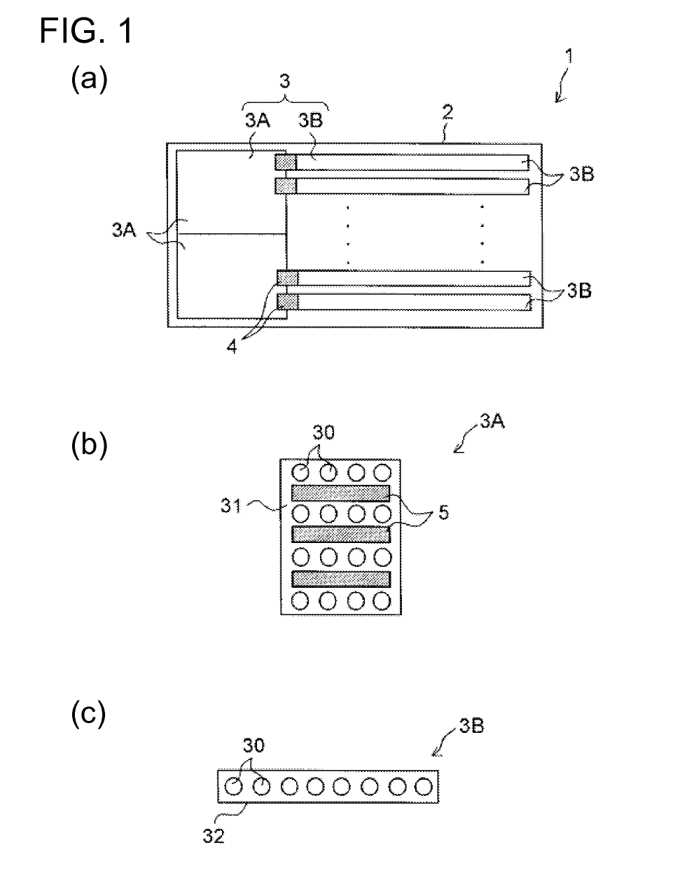

First, the LED illuminating device of the present embodiment will be described using FIG. 1.

The LED illuminating device 1 shown in FIG. 1(a) is an illuminating device in which numerous LEDs are arranged in a planar fashion on a backlight chassis 2 to form a planar light-emitting surface and is used as the backlight of a liquid crystal flat display, for example. Furthermore, an LED unit substrate 3 on which LEDs are mounted is configured as a multifractional system by combining a plurality of first LED unit substrates 3A having LED drive circuit sections along with numerous LEDs mounted on the substrates and a plurality of second LED unit substrates 3B having only a plurality of LEDs and none of the aforementioned LED drive circuit sections mounted on the substrates.

Each of the first LED unit substrates 3A is such that numerous LEDs 30 are mounted on a substrate 31 by being disposed in a matrix as shown in FIG. 1(b). Moreover, an LED drive circuit section 5 is mounted in a portion where no LED 30 is mounted. For instance, a plurality of LED drive circuit sections can be mounted between rows of the mounted LEDs 30, as shown in the figure.

Each of the second LED unit substrates 3B has no LED drive circuit section mounted thereon, with only a plurality of LEDs being mounted, and can therefore be made into a shape in which the plurality of LEDs 30 are mounted in a row on a slender substrate 32 as shown in FIG. 1(c). In addition, the emission of light of the plurality of LEDs 30 that are mounted is designed to be controlled via one of the LED drive circuit sections 5 mounted on the aforementioned first LED unit substrates 3A.

For this reason, a configuration is devised in which the LED drive circuit sections 5 for driving the LEDs 30 mounted on the second LED unit substrates 3B are collectively mounted on the first LED unit substrates 3A, and the first LED unit substrates 3A and the second LED unit substrates 3B are electrically connected via LED inter-substrate connecting sections 4.

Each of the second LED unit substrates 3B is such that only the LEDs 30 are mounted, with no LED drive circuit section 5 being mounted thereon, so it is sufficient as long as the size of the substrate is large enough for the LEDs to be mounted. For this reason, the size of a single second LED unit substrate 3B can be a substrate with a small width on which a plurality of LEDs 30 are disposed in a row, for example. Furthermore, a plurality of such second LED unit substrates 3B each formed of a small-width substrate can be provided together so as to correspond to the respective rows of the LEDs 30 mounted on the first LED unit substrates 3A, thus allowing the numerous LEDs 30 to be arranged in a lattice or matrix. By doing so, an illuminating device 1 having a specified size can be configured.

With this configuration, the substrate cost for the entire LED illuminating device 1 can be reduced, compared to a case in which the first LED unit substrates 3A are used as the entire LED unit substrate 3. The reason for this is that the first LED unit substrates 3A on which the LEDs 30 and LED drive circuit sections 5 are mounted also have a large number of signal lines and also increase the number of lamination for wiring the signal lines, thus resulting in a high substrate cost, whereas the second LED unit substrates 3B having no LED drive circuit section 5 mounted thereon require only a small substrate area, also reduce the number of electronic components to be mounted, reduce wiring, and can therefore cut down the number of substrate layers, thus lowering the substrate cost.

Moreover, if only the second LED unit substrates 3B are used as the entire LED unit substrate 3, the number of wiring lines would be increased in order to electrically wire the externally provided LED drive circuit sections 5 to the respective LEDs 30. However, when the first LED unit substrates 3A and the second LED unit substrates 3B are used in combination as in the present embodiment, the respective LEDs 30 on the first LED unit substrates 3A and the LED drive control sections 5 are disposed on the same substrate, so this eliminates a need to make wire connection between the substrates for these portions, which makes it possible to reduce the wire connection cost by that amount.

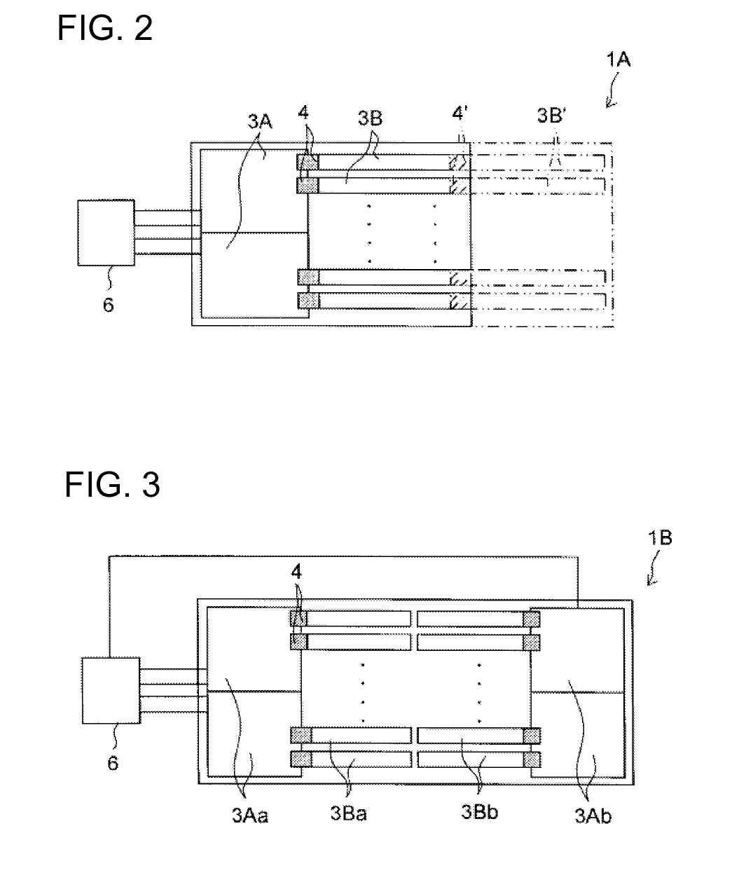

For example, when a backlight system having a total size of 1000 areas is configured by arranging LEDs of the three primary colors, red (R), green (G), and blue (B), in one area, if wiring is constructed directly to each of the LEDs, the number of wiring lines comes to a total of 6000 based on 2×3×1000 (the number of areas). If this is done by means of a system in which a plurality of substrates are electrically connected to each other via LED inter-substrate connecting sections 4 and wiring is performed between the LED drive circuit sections 5 on specified substrates and a drive circuit control section 6 (see FIG. 2), the number of signal lines is approximately 10, and the number of power supply lines is approximately 10, making a total of approximately several tens of wiring lines. Therefore, the number of wiring lines that need to be constructed can be cut down, so the wire connection cost can be reduced.

As described above, with the LED illuminating device 1 which is configured by the combined use of the first LED unit substrates 3A having the LED drive circuit sections 5 mounted on the substrates and the second LED unit substrates 3B having no LED drive circuit section 5 mounted on the substrates, an LED illuminating device is produced which reduces the wire connection cost by reducing the number of wiring lines and can also reduce the substrate cost.

There is freedom in the manner in which these first LED unit substrates 3A and second LED unit substrates 3B are combined, and an effective configuration with the desired arrangement can be selected based on the wire connection costs and substrate costs in various cases depending on the layout of the light-emitting surface. In addition, in cases where heat generation of the portions of the LED drive circuit sections 5 becomes a problem in terms of heat, it is preferable that the first LED unit substrates 3A on which the LED drive circuit sections 5 are mounted be arranged in positions where heat generation does not become an issue. Therefore, in the planar LED illuminating device 1 configured with numerous LEDs 30 mounted in a planar fashion, it is preferable that the first LED unit substrates 3A on which these LED drive circuit sections 5 are mounted be arranged in relatively low-temperature regions of the planar region.

With the planar LED illuminating device 1 on which numerous LEDs 30 are mounted in a planar fashion, the vicinity of the central portion of the plane tends to become a high temperature because heat is generated by the emission of light of the LEDs, and in the case of the LED illuminating device 1 that is planar in the up-down direction, the upper side tends to become a higher temperature than the lower side. Therefore, it is preferable that the first LED unit substrates 3A on which the LED drive circuit sections 5 are mounted be disposed in a region other than the central portion or upper side of the planar LED illuminating device 1 that has a tendency to produce a high temperature.

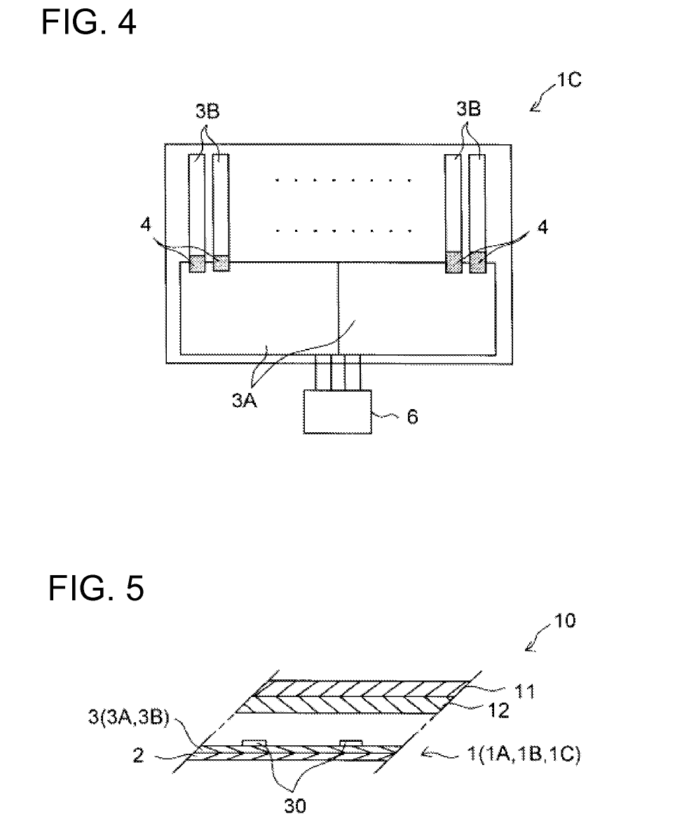

To this end, the present embodiment adopts, in the LED illuminating device 1 that is planar in the up-down direction, a first embodiment (see FIG. 2) in which the first LED unit substrates 3A on which the LED drive circuit sections 5 are mounted are installed on one side of the side portions of the device, a second embodiment (see FIG. 3) in which these first LED unit substrates 3A are installed on both sides of the side portions, and a third embodiment (see FIG. 4) in which these first LED unit substrates 3A are installed on the lower side in the up-down direction.

Next, an LED illuminating device 1A of the first embodiment in which the first LED unit substrates 3A are provided on one side of the side portions of the LED illuminating device will be described using FIG. 2.

The LED illuminating device 1A is provided with first LED unit substrates 3A, 3A on one side of the side portions as shown in the figure. Furthermore, a plurality of second LED unit substrates 3B are arranged so as to correspond to the respective rows of the LEDs 30 mounted on the first LED unit substrates 3A. In this case, the first LED unit substrates 3A and the second LED unit substrates 3B are electrically connected via LED inter-substrate connecting sections 4.

Therefore, the LEDs 30 mounted on the second LED unit substrates 3B can be driven via the LED drive circuit sections 5 mounted on the first LED unit substrates 3A.

With this configuration, a planar LED illuminating device 1A with a specified surface area can be obtained by connecting the second LED unit substrates 3B having a specified number of LEDs 30 mounted thereon to a side portion of the first LED unit substrates 3A. In this case, the number of LEDs mounted on the first LED unit substrates 3A is preferably 50% or less of all the LEDs. The reason for this is to effectively achieve both a reduction in the wire connection cost and a reduction in the substrate cost that can be obtained through the combined use of the first LED unit substrates 3A and the second LED unit substrates 3B. Moreover, if the number of LEDs of the first LED unit substrates 3A is 50% or less of the entire illuminating device, the installation positions of the first LED unit substrates 3A become positions that avoid the central portion of the illuminating device, so the increase in the temperature in the central portion is suppressed, thus making it possible to achieve uniformity in the temperature over the entire surface of the light-emitting portion.

In addition, as indicated by the imaginary lines in the figure, yet other new second LED unit substrates 3B′ can be linked to the aforementioned second LED unit substrates 3B via LED inter-substrate connecting sections 4. With this configuration, a planar LED illuminating device having an even larger size can be obtained by providing a plurality of second LED unit substrates 3B and 3B′ together on the side portion of the first LED unit substrates 3A.

With the aforementioned configuration as well, the driving of the second LED unit substrates 3B′ can be performed via the LED drive circuit sections 5 mounted on the first LED unit substrates 3A. Furthermore, the second LED unit substrates 3B′ may be substrates that are the same as the second LED unit substrates 3B or may be substrates with a smaller size having a smaller number of LEDs to be mounted than the second LED unit substrates 3B as long as their size corresponds to the size of the desired light-emitting surface.

Reference numeral 6 is a drive circuit control section for supplying signals that control the LED drive circuit sections 5 and can be disposed on the surface of the backlight chassis on the side opposite from the LED mounting surface, for example. With this configuration, there is no need to expand the size of the backlight chassis more than that of the LED mounting portion, so the frame portion of the light-emitting surface can be made narrow.

Next, an LED illuminating device 1B according to a second embodiment in which first LED unit substrates 3A are disposed on both sides of the side portions of the LED illuminating device will be described using FIG. 3.

The LED illuminating device 1B is provided with first LED unit substrates 3Aa and 3Ab on the two sides of the side portions as shown in the figure. Moreover, second LED unit substrates 3Ba are linked to the first LED unit substrates 3Aa via LED inter-substrate connecting sections 4, while second LED unit substrates 3Bb are linked to the first LED unit substrates 3Ab via LED inter-substrate connecting sections 4. Then, the second LED unit substrates 3Ba are driven via the LED drive circuit sections 5 mounted on the first LED unit substrates 3Aa, while the second LED unit substrates 3Bb are driven via the LED drive circuit sections 5 mounted on the first LED unit substrates 3Ab.

In this case as well, it is preferable that the drive circuit control section 6 be disposed on the surface of the backlight chassis on the side opposite from the LED mounting surface. Moreover, this drive circuit control section 6, the LED drive circuit sections 5 mounted on the first LED unit substrates 3Aa, and the LED drive circuit sections 5 mounted on the first LED unit substrates 3Ab are electrically connected to each other.

Next, an LED illuminating device 1C according to a third embodiment in which first LED unit substrates 3A are disposed on the lower side of the LED illuminating device will be described using FIG. 4.

As shown in the figure, the LED illuminating device 1C is such that first LED unit substrates 3A, 3A are disposed on the lower side of the device. In addition, a plurality of second LED unit substrates 3B are arranged so as to correspond to the respective columns of the LEDs 30 mounted on the first LED unit substrates 3A. In this case, the first LED unit substrates 3A and the second LED unit substrates 3B are electrically connected via LED inter-substrate connecting sections 4.

In cases where the light-emitting surface is planar in the up-down direction, it is preferable that the first LED unit substrates 3A provided with LED drive circuit sections 5 that become the source of heat generation be provided on the lower side of this light-emitting surface. With a configuration in which the first LED unit substrates 3A are disposed on the lower side, while the second LED unit substrates 3B are disposed on the upper side in this manner, it is possible to suppress the temperature increase of the LEDs by preventing the upper portion where the temperature tends to rise from reaching even higher temperatures.

In this case as well, it is preferable that the drive circuit control section 6 be disposed on the surface of the backlight chassis on the side opposite from the LED mounting surface.

Furthermore, with this configuration, by increasing the number of first LED unit substrates 3A to be arranged, the width of the LED illuminating device can easily be expanded, so this configuration can easily handle an enlargement of the display screen and is therefore suitable.

Next, a display device provided with the LED illuminating device 1 (1A, 1B, or 1C) described above will be described using FIG. 5.

As is shown in FIG. 5, the display device 10 is provided with a liquid crystal display panel 11 and an optical sheet 12, and is configured such that the LED illuminating device 1 (1A, 1B, or 1C) is disposed underneath these as a direct-type backlight.

The liquid crystal display panel 11 has a sandwich configuration in which a liquid crystal layer is sealed in between a pair of mutually facing planar transparent substrates such as glass plates or transparent resin plates, and polarizing plates are arranged on both sides thereof. Moreover, one of the transparent substrates is formed of an array substrate on which thin-film transistor (TFT) switching elements are formed, for example, and the other is formed of a color filter substrate on which three colors (red, green, and blue) of filter layers are formed, for example. In the optical sheet 12, a diffusion plate, a luminance increasing film, and the like are laminated, to diffuse the light emitted from the LED illuminating device 1 (1A, 1B, or 1C) so as to be uniform over the entire surface of the display panel.

The LED illuminating device 1 (1A, 1B, or 1C) is a device in which the LED unit substrate 3 (3A and 3B) having LEDs 30 mounted thereon as the light source is disposed on the backlight chassis 2, and the light of the LEDs is emitted toward the optical sheet 12.

The light emitted from the LED illuminating device 1 (1A, 1B, or 1C) is further diffused while passing through the optical sheet 12 and irradiates the liquid crystal display panel 11 as uniform irradiation light. The liquid crystal display panel 11 displays desired images, videos, and the like by (for example) supplying respective pixel signals to a plurality of pixels arranged in a matrix and adjusting the transmittance of the light in each of the pixels.

In this case as well, it is preferable that the drive circuit control section that supplies control signals to the LED drive circuit sections provided in the LED illuminating device 1 (1A, 1B, or 1C) be disposed on the surface of the backlight chassis on the side opposite from the LED mounting surface. With this configuration, the frame of the display portion does not need to be expanded more than the LED mounting portion, so the frame portion of the display device can be made narrower, thus resulting in a display device 10 that has superior design characteristics.

As described above, the planar liquid crystal display panel 11 can be irradiated with uniform irradiation light by using the LED illuminating device 1 (1A, 1B, or 1C) on which the LEDs 30 are mounted in a lattice or matrix as the backlight.

In addition, the use of the LED illuminating device 1 (1A, 1B, or 1C) according to the present embodiment results in an LED illuminating device that has reduced wire connection cost and substrate cost, thus making it possible to reduce the manufacturing cost of the display device 10.

As described above, the present invention devises an LED illuminating device that is configured such that first LED unit substrates having LED drive circuit sections mounted thereon and second LED unit substrates having no LED drive circuit section mounted thereon are used in combination, and such that the second LED unit substrates are driven via the LED drive circuit sections mounted on the first LED unit substrates. Therefore, it is possible to obtain an LED illuminating device that reduces the wire connection cost and that can also reduce the substrate cost. Furthermore, because a display device is produced, which is provided with this LED illuminating device as the backlight, a display device that can reduce the manufacturing cost can be obtained using a combined configuration in accordance with the size of the display screen.

### INDUSTRIAL APPLICABILITY

The LED illuminating device according to the present invention is configured such that a plurality of LED unit substrates are combined and such that the wire connection cost and the substrate cost can be reduced. Therefore, the manufacture of planar LED illuminating devices with different sizes is facilitated, so this LED illuminating device can be suitably utilized as the backlight of a liquid crystal display device for which various sizes are demanded.

### DESCRIPTION OF REFERENCE CHARACTERS

1 LED illuminating device
2 backlight chassis
3 LED unit substrate
3A first LED unit substrate
3B second LED unit substrate
4 LED inter-substrate connecting section
5 LED drive circuit section
6 drive circuit control section
6 display device
10 liquid crystal display panel
30 LED
31 substrate
32 substrate

1. An LED illuminating device, comprising: LED unit substrates on which a plurality of LEDs are mounted; an LED drive circuit section; and a drive circuit control section,
wherein a first LED unit substrate having said LED drive circuit section mounted thereon and a second LED unit substrate having no LED drive circuit section mounted thereon are provided as said LED unit substrates, and
wherein said second LED unit substrate is driven via said LED drive circuit section mounted on said first LED unit substrate.

2. The LED illuminating device according to claim 1, wherein in formation of a light-emitting surface by disposing said LED unit substrates in one surface of a backlight chassis, said second LED unit substrate is disposed in a region that becomes a high-temperature portion when light is emitted.

3. The LED illuminating device according to claim 1, wherein said LED illuminating device is a planar illuminating device in which said LED unit substrates are arranged in a plane in a backlight chassis, with said first LED unit substrate being disposed in a peripheral portion of said plane, and said second LED unit substrate being disposed on an inner side thereof, and said first LED unit substrate and said second LED unit substrate are electrically connected via an LED inter-substrate connecting section.

4. The LED illuminating device according to claim 1, wherein said second LED unit substrate is formed of a plurality of small-width substrates, with the small width being such that the LEDs can be mounted in a column.

5. The LED illuminating device according to claim 4, wherein said first LED unit substrate is disposed on one of side portions of a light-emitting surface, while said second LED unit substrate is disposed on the other one of the side portions.

6. The LED illuminating device according to claim 5, wherein another said second LED unit substrate is additionally linked to said second LED unit substrate via another said LED inter-substrate connecting section.

7. The LED illuminating device according to claim 4, wherein said first LED unit substrates are disposed on both of side portions of a light-emitting surface, and said second LED unit substrate is disposed therebetween.

8. The LED illuminating device according to claim 7, wherein a plurality of substrates are provided together as said second LED unit substrate, and each of the substrates is connected to one of said first LED unit substrates on the side portions.

9. The LED illuminating device according to claim 4, wherein a light-emitting surface is planar in an up-down direction, and said first LED unit substrate is provided on the lower side of the light-emitting surface, while said second LED unit substrate is provided on the upper side.

10. A display device comprising a liquid crystal display panel and the LED illuminating device of claim 1 as the backlight of said liquid crystal panel.

11. The display device according to claim 10, wherein the drive circuit control section that supplies a control signal to the LED drive circuit section provided in said LED illuminating device is disposed on a surface of a backlight chassis on a side opposite from an LED mounting surface.
